(19) United States
(12) Patent Application Publication
(10) Pub. No.: US 2014/0044005 A1
(43) Pub. Date: Feb. 13, 2014

(54) SYSTEM AND METHOD FOR CONDUCTING WIRELESS SITE SURVEYS USING WIRELESS NETWORK DESIGN CRITERIA

(71) Applicants: Samuel Joseph Keys, (US); Ernest William Brown, (US); Alexander Chernyakhovsky, Los Angeles, CA (US); Adrian Harris Warren, Los Angeles, CA (US)

(72) Inventors: Samuel Joseph Keys, (US); Ernest William Brown, (US); Alexander Chernyakhovsky, Los Angeles, CA (US); Adrian Harris Warren, Los Angeles, CA (US)

(73) Assignee: Xirrus, Inc., Thousand Oaks, CA (US)

(21) Appl. No.: 13/353,880

(22) Filed: Jan. 19, 2012

(51) Int. Cl. H04W 16/22

(52) U.S. Cl. CPC H04W 16/225
USPC 370/254

(57) ABSTRACT

A system for conducting wireless site surveys of a wireless environment is provided. A wireless interface controller controls a wireless interface during a scan of a wireless frequency band. A user interface module receives a set of wireless network design criteria, and a measurement module obtains a set of wireless signal information based on a set of wireless signals received during the scan of the wireless frequency band. An analysis module compares the set of wireless signal information to the set of wireless network design criteria and automatically determines whether the set of wireless network design criteria is, at least in part, satisfied. The user interface module provides an indicator that indicates whether the set of wireless network design criteria is, at least in part, satisfied.

### FIELD OF THE INVENTION

This invention relates to wireless networking and more particularly to conducting wireless site surveys.

### BACKGROUND

Designing wireless networks that provide adequate network quality in an operating environment (e.g., an office building) is a non-trivial task. Environmental factors can affect the propagation of radio frequency (RF) waves. For example, walls, doors, windows, and the like can reflect, refract, and attenuate RF waves in ways that may be difficult to predict.

As a result, the operating environment a wireless network is deployed in is a significant variable to consider when designing the wireless network for that environment. The quality of the wireless network may depend on, for example, the number of wireless access points deployed and their respective installation locations.

Accordingly, network designers may perform a wireless site survey to determine whether the wireless environment provides suitable wireless network access. Wireless site surveys, however, can be sophisticated technical procedures that may require the expertise of a professional network designer. Therefore a need exists for an improved approach to conducting wireless site surveys.

### SUMMARY

A system for conducting wireless site surveys of a wireless environment is provided. A wireless interface controller controls a wireless interface during a scan of a wireless frequency band. A user interface module receives a set of wireless network design criteria, and a measurement module obtains a set of wireless signal information based on a set of wireless signals received during the scan of the wireless frequency band. An analysis module compares the set of wireless signal information to the set of wireless network design criteria and automatically determines whether the set of wireless network design criteria is, at least in part, satisfied. The user interface module provides an indicator that indicates whether the set of wireless network design criteria is, at least in part, satisfied.

A computer-implemented method of conducting a wireless site survey for a wireless environment is also provided. A set of wireless network design criteria is received. A wireless frequency band is scanned to receive a set of wireless signals. Individual wireless signals in the set of wireless signals are measured to obtain a set of wireless information associated with the set of wireless signals. The set of wireless signal information is compared to the set of wireless network design criteria, and whether the set of wireless network design criteria is, at least in part, satisfied is determined. An indicator is provided that indicates whether the set of wireless network design criteria is, at least in part, satisfied.

A method of conducting a wireless site survey for a wireless environment is further provided. A set of wireless network design criteria is provided to a wireless network design system. The wireless network design system is positioned at a location within the wireless environment. A wireless frequency band is scanned using the wireless network design system, and whether the set of wireless network design criteria is, at least in part, satisfied is determined based on an indicator automatically provided by the wireless network design system. The wireless environment is reconfigured when the indicator provided by the wireless network design system indicates that at least one wireless network design criterion in the set of wireless network design criteria is not satisfied.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is an example of an implementation of a wireless network design system.

FIG. 2 is an example of an implementation of a user interface that receives a set of wireless network design criteria.

FIG. 3 is an example of an implementation of a user interface that receives a set of channel selections corresponding to channels to monitor during a wireless site survey.

FIG. 4 is an example of an implementation of a user interface that displays the results of a wireless site survey.

FIG. 5 is an example of a site undergoing a wireless site survey using a wireless network design system.

FIG. 6 is the site undergoing the wireless site survey of FIG. 5 after the wireless environment is reconfigured based on the results of the wireless site survey.

FIG. 7 is a flowchart of example method steps for conducting a wireless site survey using wireless network design criteria.

### DETAILED DESCRIPTION

A system and method for conducting wireless site surveys using wireless network design criteria are provided. A user may establish a wireless environment by distributing wireless access devices throughout a site. The user may specify a set of wireless network design criteria that corresponds to a desired quality of wireless service level. The user may then collect and measure wireless signals and compare the wireless signals to the design criteria as part of a wireless site survey. An audio or visual indicator is provided to automatically indicate whether the wireless environment satisfies the wireless network design criteria. If the wireless environment does not satisfy the design criteria, then the user may reconfigure the wireless environment and repeat the live site survey until the wireless design criteria is satisfied. In this way, a network designer may advantageously determine whether a wireless environment provides a desired quality of wireless service level while actively surveying the site. As a result, this improved approach to conducting live site surveys may allow novice users to conduct live site surveys.

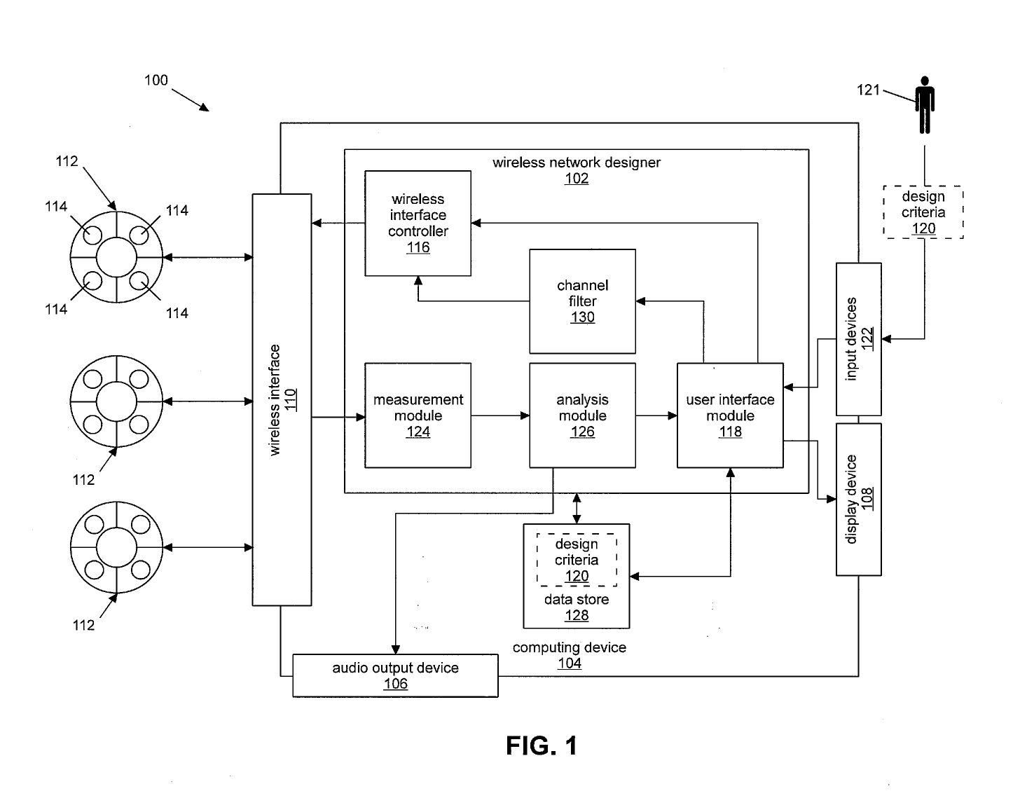

Referring to FIG. 1, an example of an implementation of a wireless network design system 100 is shown. The wireless network design system 100, in this example, includes a wireless network designer 102 residing at a computing device 104. The computing device 104 may be, for example, a desktop computer, laptop computer, tablet computer, palmtop computer, mobile telephone, or any other computer-based device. The computing device 104 may include an audio output device 106 that provides audio output during a live site survey and a display device 108 for displaying a user interface as discussed further below. The computing device 104 is also network-enabled and thus includes a wireless interface 110 that transmits and receives wireless signals. The wireless network interface 110 may be, for example, a wireless network interface controller, i.e., a wireless network interface adapter or wireless network interface card. The wireless interface 110, in this example, is configured to exchange wireless signals that conform to the IEEE 802.11 standard. Accordingly, the wireless network design system 100 may be in signal communication with one or more wireless access devices 112.

A wireless access device 112 provides wireless access to a wired network such as, for example, a local area network (LAN) or a wide area network (WAN), e.g., the Internet. Accordingly a wireless access device 112 includes one or more access points 114, i.e., one or more transceivers (e.g., radios). Some wireless access devices 112 may include more than one access point 114 for exchanging wireless signals. A wireless access device 112 that includes multiple access points 114 may be referred to as a wireless array.

Access points 114 in a wireless array 112 may operate in the 2.4 GHz (gigahertz) and 5 GHz frequency bands. Under the IEEE 802.11 standards, these frequency bands are divided into channels with each channel corresponding to a particular frequency. The IEEE 802.11b and 802.11g standards, for example, divide the 2.4 GHz frequency band into fourteen channels, channels 1-14, spaced 5 MHz (megahertz) apart. The IEEE 802.11a standard, as another example, divides the 5 GHz band into twenty-three non-overlapping channels.

The wireless network designer 102 includes modules that facilitate the measurement and analysis of wireless signals in a wireless environment. The wireless network designer 102, in this example, includes: a wireless interface controller 116 that controls (i.e., drives) the wireless interface 110 during a wireless site survey; a use interface module 118 that receives wireless network design criteria 120 from a user 121 via one or more input devices 122 and provides user interfaces at a display device 108; a measurement module 124 that measures wireless signals received at the wireless interface 110 from wireless access devices 112; and an analysis module 126 that determines whether the wireless signals satisfy the wireless network design criteria 120. Input devices 122 may include, for example, a keyboard, a pointing device (e.g., mouse, stylus, touchscreen, touchpad, etc.), and the like. The display device 108 may be, for example, a computer monitor, a computer screen, or other electronic visual displays. The wireless network design system 100, in this example, includes a data store 128 that stores the wireless network design criteria 120 received from the user 121. The wireless network designer 102 may also include a channel filter 130 that instructs the wireless interface 110 to selectively monitor wireless channels during a wireless site survey as discussed in further detail below.

Wireless network design criteria 120 may include, for example: a minimum number of wireless access devices 112 observed (i.e., detected) in the wireless environment; a minimum number of wireless access points 114 observed in the wireless environment; and the quality of wireless signals observed in the wireless environment. The quality of wireless signals may be assessed based on the strength of received wireless signals and the signal-to-noise ratio (SNR) observed in the wireless environment.

The strength of received signals, i.e., received signal strength, may be quantified as a dBm value: the power ratio in decibels (dB) of the measured power in Watts (W) of a wireless signal referenced to one milliwatt (mW). A suitable signal strength for wireless signals broadcast in a wireless environment may be between, for example, around −100 dBm to around −20 dBm.

To measure and analyze the wireless environment, the wireless network design system 100 may perform a series of measurement cycles to observe the wireless signals the wireless access devices 112 broadcast throughout the wireless environment. During a measurement cycle, the wireless network designer 102 may instruct the wireless interface 110 to tune to a particular wireless channel. Once tuned to a wireless channel, the wireless network designer 102 monitors (i.e., listens) for wireless signals broadcast on that channel, extracts data from wireless signals received at the wireless interface 110 from the wireless access devices 112, and compares the extracted data to the wireless network design criteria 120. After completing a measurement cycle, the wireless network designer 102 instructs the wireless interface 110 to tune to a new channel and repeats the monitoring, measurement, and comparison procedures. Based on the results of the measurement cycles, the wireless network designer 102 determines whether the wireless environment satisfies the wireless network design criteria 120. As discussed further below, the wireless network design system 100 provides visual or audible indicators that indicate whether the set of wireless design criteria 120 is or is not satisfied.

The wireless interface controller 116, in this example, controls the wireless interface 110 during a wireless site survey. The wireless interface controller 116 issues commands to the wireless interface 110 that instruct the wireless interface to tune to a particular wireless channel and monitor that wireless channel in order to collect wireless signals broadcast on that channel. As an example, the wireless interface controller 116 may instruct the wireless interface 110 to scan the 2.4 GHz and 5 GHz frequency bands during a wireless site survey. During the scan, the wireless interface 110 iteratively tunes to the channels of frequency bands, e.g., channels 1, 6, 11, etc. in the 2.4 GHz frequency band under the IEEE 802.11b/g standard and channels 36, 40, 44, etc. in the 5 GHz frequency band under the IEEE 802.11a standard.

While the wireless interface 110 is tuned to a channel, the wireless interface may actively monitor the channel by broadcasting probe requests. If an access point 114 is tuned to the same channel, the access point may transmit a response to the wireless interface. The wireless network design system 100 may then associate with the access point 114, exchange a series of wireless signals, and measure the wireless signals to determine whether the wireless network design criteria 120 is satisfied as discussed further below. Additionally or alternatively, the wireless network design system 100 may measure the wireless signals received as responses to the probe requests to determine whether the wireless design criteria 120 is satisfied. The wireless interface 110 may also passively monitor the channel by listening for beacons broadcast by one or more access points 114 tuned to the same channel. An access point 114 may broadcast beacons at a periodic interval, e.g., every one-hundred milliseconds (ms), to announce its presence in the wireless environment. Beacons broadcast by an access point 114 may include identifying information such as, for example, the SSID for the access point (service set identifier). The wireless network design system 100 may measure the wireless signals received as beacons broadcast by the access points 114 to determine whether the wireless network design criteria 120 is satisfied. Additionally or alternatively, the wireless network design system 100 may use the information in the probe requests to associate with the access points 114 and initiate an exchange of wireless signals to determine whether the design criteria 120 is satisfied as mentioned above.

The wireless network design system 100 may be configured to monitor each available channel in the wireless frequency bands. To improve performance, however, the wireless network designer 102 may include a channel filter 130 to selectively monitor the channels of the frequency bands. The channel filter 130 may be, for example, a driver that instructs the wireless interface controller 116 to monitor a set of specified channels. A user 121 may provide the wireless network design system 100 with user input corresponding to a set of channels to monitor during the wireless site survey. Accordingly, the channel filter 130 may instruct the wireless interface controller 116 to skip over or ignore unselected channels during the scan of the wireless environment. The user 121 may also selectively configure the channel filter 130 such that the wireless interface 110 monitors channels in an active mode or a passive mode. The selection of an active mode or passive mode may also be received at the wireless network design system 100 as user input. In addition, a user 121 may specify a desired scan interval, i.e., the amount of time the wireless interface 110 monitors a channel before tuning to the next channel. The wireless network design system 100 may similarly receive the scan interval from the user 121 as user input.

Having received wireless signals at the wireless interface 110, the measurement module 124 processes the received wireless signals to extract data from the wireless signals and determine the quality of the wireless signals. The data the measurement module 124 extracts from the wireless signals may be related to the access points 114 that broadcast the wireless signals. Data extracted from the wireless signals may include, for example: the base physical address of the wireless access device 112 and the respective physical addresses of the access points 114, e.g., the BSSID (basic service set identifier); the respective SSIDs of the access points; information indicating whether the channel is bonded; and the like. Channel bonding refers to the technique of broadcasting wireless signals on two separate non-overlapping channels to increase throughput. The measurement module 124 may determine whether the channel is bonded by identifying the primary channel in the received packet and by examining the packet flag of the received packet. The measurement module 124 may also determine the signal strength of the wireless signals by converting the power of the wireless signal to a dBm value as discussed above.

The measurement module 124, in this example, may also determine the signal-to-noise ratio observed in the wireless environment based on the wireless signals received at the wireless interface 110. The measurement module 124 may quantify the SNR as an integer value. The measurement module 124, in this example, may determine the SNR by dividing the average power of the received wireless signals by the noise floor of the average power of noise observed in the wireless environment. Signal-to-noise ratio may be defined as the power ratio between a signal (i.e., meaningful information) and background noise (i.e., unwanted signals) where P is the average power. Accordingly, the SNR may be obtained using the following equation:

$$S N R = \frac{{P}_{signal}}{⌊ {P}_{noise} ⌋}$$

where P_{signal} is the average power of the received wireless signals and Pₙₒᵢₛₑ is the average power of noise observed in the wireless environment.

Having measured the received wireless signals, the analysis module 126 compares the measurement information to the wireless network design criteria 120. For example and as discussed further below, the analysis module 120 may: compare signal strength of the received wireless signals to the signal strength criterion; compare the observed signal-to-noise ratio to the SNR criterion; compare the number of observed wireless access devices 112 to the specified minimum number of wireless access devices; and compare the number of observed access points 114 to the specified minimum number of access points. The analysis module 126 may initiate visual or audible feedback that indicates whether the set of wireless network design criteria 120 is satisfied. For example, the analysis module 126 may instruct the user interface module 118 to adjust the user interface displayed at the display device 108 to visually indicate whether the set of design criteria 120 is satisfied. Additionally or alternatively, the analysis module 126 may instruct the audio output device 106 to playback a tone, audio file, or the like, when the set of wireless network design criteria 120 is satisfied.

The analysis module 126 may determine whether the overall set of wireless network design criteria 120 is satisfied globally. If each individual wireless network design criterion in the set of wireless network design criteria 120 is satisfied, then the analysis module 126 may determine that the set of wireless network design criteria is satisfied globally. For example, if the analysis module 126 determines that the wireless environment includes at least the minimum number of wireless access devices 112 or access points 144, that the strength of received wireless signals are at least equal to the minimum signal strength value, and that the observed SNR in the wireless environment does not equal or exceed, i.e., is below, the maximum SNR value, then the analysis module may determine the set of wireless network design criteria 120 is satisfied globally. If the analysis module 126 determines that at least one individual wireless network design criterion is not satisfied, then the analysis module may determine that the set of wireless network design criteria 120 is not satisfied.

The analysis module 126 may also determine whether a wireless network design criterion is satisfied on an individual basis. For example, the analysis module 126 may determine whether wireless signals broadcast on each channel observed in the wireless environment (e.g., channels 1, 6, 9, and 13) satisfy the wireless signal strength criterion. If wireless signals broadcast on each of the observed channels satisfy the wireless signal strength criterion, then the analysis module 126 may determine that the wireless signal strength criterion for the set of wireless network design criteria 120 is satisfied. If some of the wireless signals broadcast on one of the observed channels (e.g., channel 6) do not satisfy the wireless signal strength criterion, however, then the analysis module 126 may determine that the wireless signal strength criterion for the set of wireless network design criteria 120 is not satisfied. In turn the analysis module 126 may determine that the set of wireless network design criteria 120 is not satisfied globally.

The analysis module 126 may determine that an individual wireless network design criterion is (or is not) satisfied based on whether a predetermined amount of received wireless signals satisfy the criterion. The amount of wireless signals that must satisfy the criterion may be a default or user configurable setting. For example, the predetermined amount of wireless signals that must satisfy the wireless network design criterion may be specified as 75%. Accordingly, if 25% or more of received wireless signals do not satisfy the wireless signal strength criterion, then the analysis module 126 may determine that the wireless signal strength criterion is not satisfied, either globally or for a particular channel as discussed above. Likewise if 75% of received wireless signals do satisfy the wireless signal strength criterion, then the analysis module 126 may determine that the wireless signal strength criterion is satisfied. A user may specify alternative percentages to suit the needs of a particular wireless environment. It will be understood that additional or alternative approaches to determining whether the set of wireless network design criteria 120 is satisfied may be selectively employed according to the wireless access needs of the wireless environment under survey.

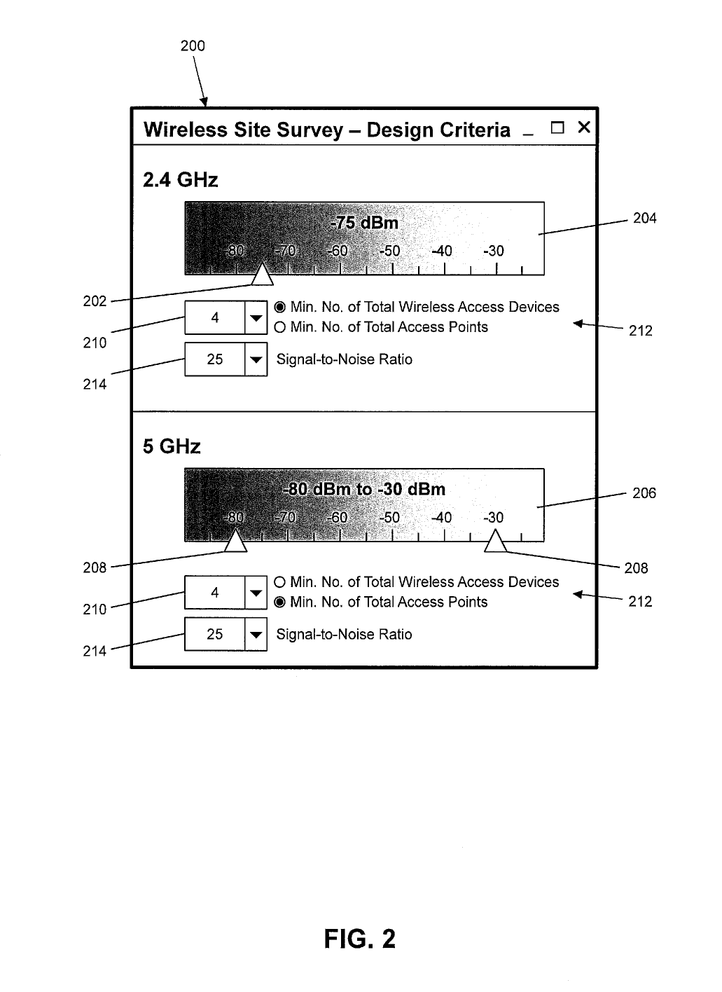

The user interface module 118 provides one or more user interfaces that receive the set of wireless network design criteria 120 from the user 121s and that provide one or more visual indicators to indicate whether the wireless network design criteria is satisfied. Referring to FIG. 2, an example of an implementation of a user interface 200 that receives the set of wireless network design criteria 120 from a user 121 is shown. The user interface 200 may include various user interface input elements for receiving the wireless network design criteria 120 as user input. Input elements may include, for example, checkboxes, combo boxes, drop-down lists, radio buttons, sliders, spinners, textboxes, and the like.

As seen in the example user interface 200 shown in FIG. 2, a user may specify wireless network design criteria 120 for both the 2.4 GHz and 5 GHz frequency bands. The user interface may include a slider 202 for setting a desired wireless signal strength level 204. The wireless signal strength criterion 204 may be specified as a threshold value, e.g., −75 dBm, such that wireless signals above the threshold value, e.g., −70 dBm, satisfy the wireless signal strength criterion and wireless signals below the threshold value, e.g., −80 dBm, do not satisfy the wireless signal strength criterion. The wireless signal strength criterion may additionally or alternatively be specified as a range 206 using a minimum signal strength value and a maximum signal strength value, e.g., −80 dBm to −30 dBm, such that wireless signals within the range, e.g., −76 dBm and −35 dBm, satisfy the signal strength range criterion and wireless signal falling outside the range, e.g., −84 dBm and −25 dBm, do not satisfy the signal strength range criterion. The user interface 200 may include a slider 202 for specifying a signal strength threshold 204 and a pair of sliders 208 to specify a signal strength range 206 as shown by way of example in FIG. 2.

A user 121 may also specify that the wireless network design system 100 should observe a minimum number of wireless access devices 112 (“mode 2”) or a minimum number of access points 114 (“mode 3”) in order for the wireless network design criteria 120 to be satisfied. The minimum number of wireless access 112 devices refers to the total number of distinct wireless access devices observed in the wireless environment, e.g., the total number of wireless arrays. The minimum number of total access points 114 refers to the total number of distinct access points observed in the environment even if, for example, the distinct access points are included in the same wireless array 112. Accordingly, four distinct wireless arrays 112 each having four access points 114 results in a wireless environment that includes sixteen distinct access points. The user interface 200 may include drop-down lists 210 to specify the minimum number of total wireless access devices 112 or access points 114 as shown by way of example in FIG. 2. The user interface may also include a pair of radio buttons 212 to specify whether the wireless network design system 100 should determine the total number of wireless access devices 112 or the total number of access points 114.

The measurement module 124 may determine the total number of distinct access points 114 based on the respective physical addresses of the access points, e.g., the BSSIDs of the access points. Each access point 114 may be respectively associated with a unique physical address, e.g., 00:0f:7d:01:db:c4. The measurement module 124 may thus extract the BSSID from received wireless signals and count the total number of unique physical addresses observed in order to determine the total number of distinct access points 114 observed in the wireless environment. The measurement module 124 may determine the total number of distinct wireless access devices 112 in the wireless environment in a similar fashion if the wireless access device includes a single access point 114. Where the wireless access devices 112 are wireless arrays having multiple access points 114, the measurement module 124 may determine the total number of distinct wireless arrays based on the base physical address (e.g., base MAC address) of the wireless access device. Access points 114 in wireless arrays 112 may respectively correspond to physical addresses that increment from the base physical address. Accordingly, the measurement module 124 may determine the total number of wireless access devices 112 by counting the number of unique base physical addresses observed during the scan of the wireless frequency band. Wireless signals (e.g., wireless beacons) may include additional information extracted by the wireless network designer 102, which indicates, e.g., the model number of a wireless access device 112, the number of access points 114 in a wireless array, etc.

Also seen in FIG. 2, a user 121 may specify a maximum signal-to-noise ratio, e.g., 25, such that an observed SNR that is below the specified maximum SNR, e.g., 22, satisfies the SNR criterion and an observed SNR that exceeds the specified maximum SNR, e.g., 29, does not satisfy the SNR criterion. The user interface 200 may include, for example, a drop-down list 214 for specifying the maximum signal-to-noise ratio. The measurement module 124 may determine the signal-to-noise ratio observed in the wireless environment as discussed above. If the analysis module 126 determines that the observed signal-to-noise ratio exceeds the specified maximum signal to noise ratio, then the analysis module 126 may determine that the overall set of wireless network design criteria 120 is not satisfied.

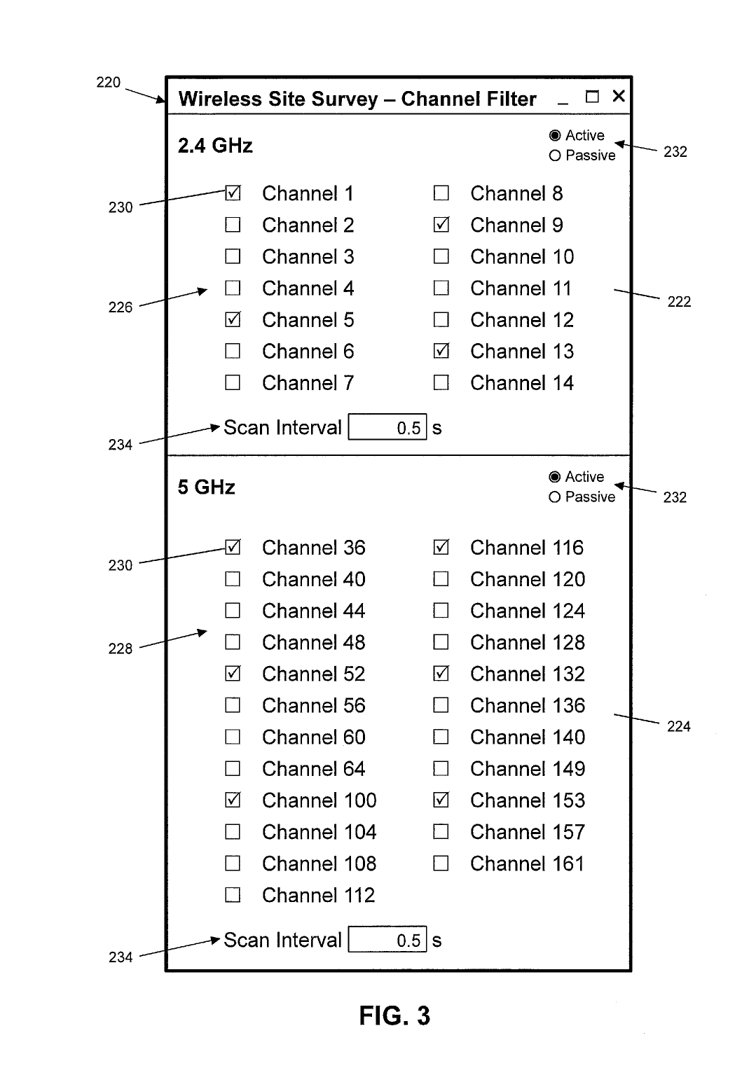

As discussed above, the wireless network designer 102 may include a channel filter 130 for selectively monitoring channels during a wireless site survey. Referring to FIG. 3, an example of an implementation of a user interface 220 that receives a set of channel selections corresponding to channels to monitor during a wireless site survey is shown. As seen in this example, the user interface 220 includes panels 222 and 224 to select channels in the 2.4 GHz and 5 GHz frequency bands respectively. The user interface 220 may include a grid of checkboxes 226 and 228 for selecting and deselecting channels to monitor. Individual checkboxes 230 in the checkbox grids 226 and 228 may be respectively associated with a channel in the frequency band. When a checkbox 230 is selected, the channel filter 130 may instruct the wireless interface controller 116 to monitor the selected channel during a scan of the frequency band. When a checkbox 230 is not selected, the channel filter 130 may instruct the wireless interface controller 116 to skip or ignore the unselected channel during the scan of the frequency band.

The user 121 may also specify whether the wireless network interface 110 should monitor the channels in an active or passive mode. The user interface 220, in this example, includes a pair of radio buttons 232 for respectively selecting the active mode or passive mode. Additionally, a user 121 may specify the scan interval as mentioned above. The user interface 220, in this example, may include a textbox 234 for specifying the scan interval, e.g., 0.5 seconds (s).

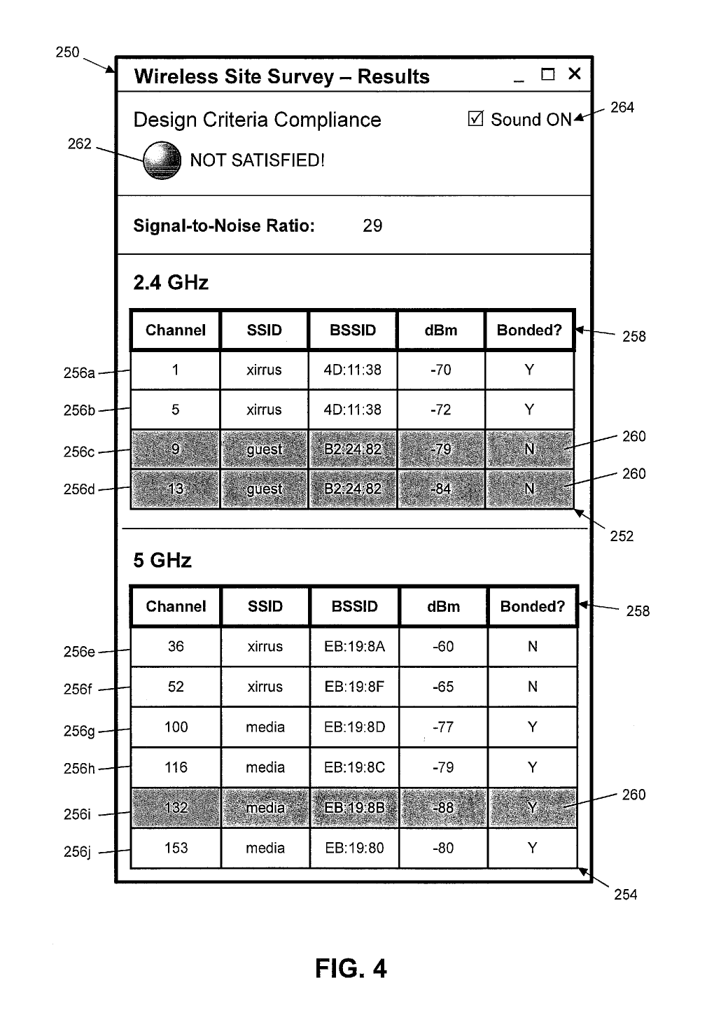

Once the scan of the wireless frequency bands is complete, the user interface module 118 may construct a user interface that includes the results of the scan as well as indicators that indicate whether the set of wireless network design criteria 120 is satisfied. The user interface module 118 may present the user interface at the display device 108 to provide the results of the wireless site survey. Referring to FIG. 4, an example of an implementation of a user interface 250 that displays the results of a wireless site survey is shown. The user interface module 118 may construct the user interface 250 displaying the results of the wireless site survey based on the results obtained by the analysis module 126 in comparing the design criteria 120 to the wireless signals observed.

The user interface 250 displaying the results of the wireless site survey, in this example, displays respective result tables 252 and 254 for the 2.4 GHz and 5 GHz frequency bands. The result tables 252 and 254 may include a line item 256 for each of the wireless channels observed during the scan of the frequency bands as shown by way of example in FIG. 4. The result tables 252 and 254 may also include information 258 relating to wireless signals received on the observed channels including, for example: the channel number; the SSID for the channel; the BSSID for the access point broadcasting on the channel; the signal strength (e.g., dBm) of wireless signals broadcast on the channel; and a channel bonding status that indicates whether the channel is bonded.

The user interface module 118 may also include in the user interface 250 visual indicators 260 and 262 that indicate whether the wireless signals broadcast on an observed channel satisfy the specified network design criteria 120, e.g., the signal strength criterion. For example, the user interface module 250 may selectively adjust the background color 260 of a channel line item 256 based on whether wireless signals broadcast on that channel satisfy the wireless network design criteria 120. The line items 256a-b, 256-h, and 256j shown by way of example in FIG. 4 are displayed as having a white background when design criteria 120 are satisfied and lines items 256c-d and 256i are displayed as having a gray background when design criteria are not satisfied. Other colors may be selectively employed to visually indicate whether wireless signals broadcast on observed channels do or do not satisfy the wireless network design criteria, e.g., green and red respectively.

In FIG. 2, the threshold signal strength 204 for the 2.4 GHz frequency band is set to −75 dBm, and the signal strength range 206 for the 5 GHz frequency band is set as −80 dBm to −30 dBm. In FIG. 4, channel 9 and channel 13 in the 2.4 GHz frequency band have signal strength values, −79 dBm and −84 dBm respectively that are below the specified signal strength threshold of −75 dBm. Similarly channel 132 in the 5 GHz frequency band has a signal strength value of −88 dBm, which falls outside the specified signal strength range of −80 dBm to −30 dBm. Accordingly, the user interface module 118 has configured the respective line items 256c-d and 256i for channels 9, 13, and 132 to include a gray background 260 thus indicating wireless signal transmitted on those channels do not satisfy the specified design criteria 120.

The user interface 250 displaying the results of the wireless site survey may also include a pass/fail display element 262, e.g., a global compliance indicator, that visually indicates whether the overall set of wireless network design criteria 120 is satisfied, e.g., the signal strength of observed wireless signals, the minimum number of wireless access devices 112 or access points 114, and the signal-to-noise ratio. If the analysis module 126 determines that these wireless network design criterions are cumulatively satisfied, the global compliance indicator 262 may indicate that the set of wireless network design criteria 120 is satisfied. The user interface module 118 may indicate compliance or noncompliance with the overall set of design criteria 120 based on a selective coloring (e.g., white/gray, green/red, etc.) of the global compliance indicator 262. Because some of the observed wireless signals shown by way of example in FIG. 4 (e.g., channels 9, 13, and 132) do not satisfy the signal strength criterion, the user interface module 118 has configured the global compliance indicator 262 to have a gray color thus indicating that the wireless environment does not satisfy the specified wireless network design criteria 120.

The wireless network design system 100 may additionally indicate satisfaction of or compliance with the wireless network design criteria 120 using an audible indicator. If the analysis module 126 determines that the set of design criteria 120 is satisfied, the analysis module may instruct the audio output device 106 to initiate playback of a tone, audio file, or other audible indicator as mentioned above. The user interface 250 displaying the results of the wireless site survey may also include an input element 264, e.g., a checkbox, to toggle the use of an audible indicator to indicate satisfaction of the wireless network design criteria 120.

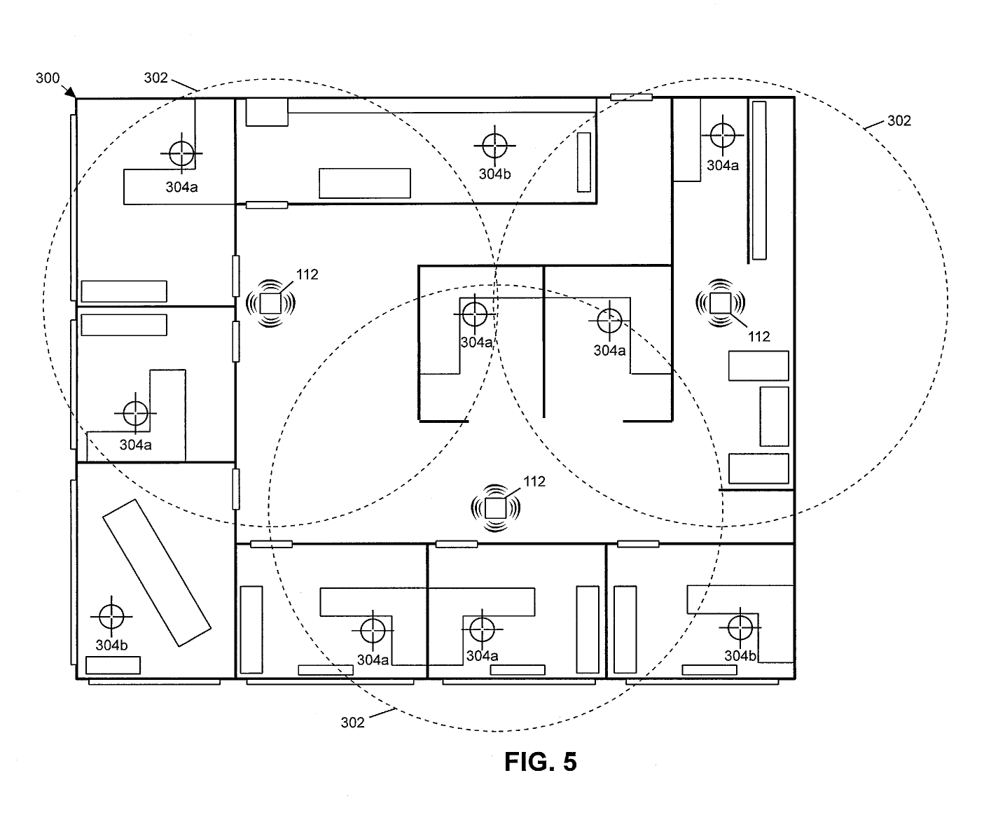

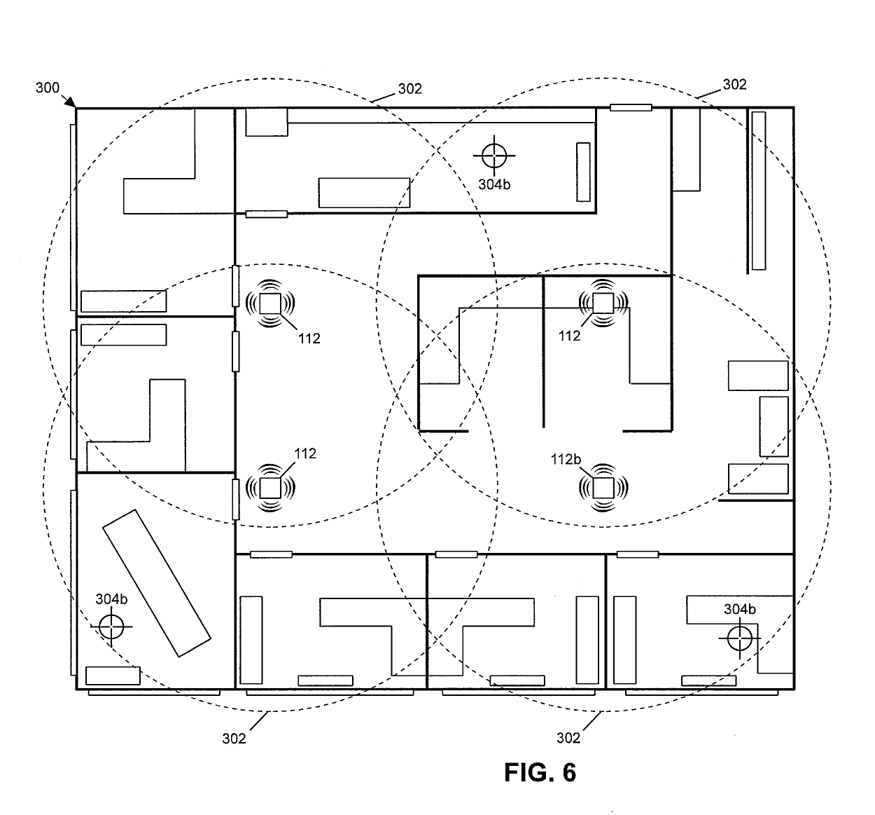

Referring now to FIG. 5 and FIG. 6, an example of a site 300 undergoing a wireless site survey using a wireless network design system 10 is shown. The site 300 under survey, in this example, corresponds to an office for which a wireless environment is being setup and configured. As shown by way of example in FIG. 5, three wireless access devices 112 have been deployed at the site 300 each providing respective wireless coverage areas 302. A user may provide a set of wireless network design criteria 120 to the wireless network design system 100 as discussed above. The wireless network design criteria 120 corresponds to a desired level or quality of wireless service sought at the site 300 under survey. The user 121 may then select various measurement locations 304 at the site 300 to conduct a series of wireless site surveys in order to assess the quality of wireless service at those measurement locations. The wireless network design system 100 may indicate that the wireless environment shown by way of example in FIG. 5, satisfies the wireless network design criteria 120 at most measurement locations 304a. At some locations 304b, however, the wireless network design system 100 may indicate that the set of wireless network design criteria 120 is not satisfied resulting in inadequate wireless service at those locations. As seen in FIG. 5, for example, measurement locations 304b at the top, bottom-left, and bottom-right of the site 300 under survey receive little or no wireless coverage.

In response to the determination that the wireless environment does not satisfy the wireless network design criteria 120 at some locations 304b, the user may reconfigure the wireless environment. Reconfiguring the wireless environment may include, for example: adjusting the number of wireless access devices 112 or access points 114 deployed in the wireless environment; adjusting the location of the wireless access devices within the wireless environment; adjusting the orientation of wireless access devices where, e.g., the wireless access devices include directional antennas; selecting a different type of wireless access device, e.g., a wireless array having eight access points instead of four access points; redistributing channel assignments among wireless access devices or among access points in a wireless array; adjusting the transmitting power of a transceiver; and the like. It will be understood that the configuration of the wireless environment will depend on the particular site the wireless environment is deployed in as well as the particular requirements for wireless service within the site. The wireless network design system 100 provided advantageously helps to determine when those requirements are satisfied.

Referring back to the example site 300 under survey in FIG. 5 and FIG. 6, a user may determine that an additional wireless access device 112 is needed to satisfy the wireless network design criteria 120 at each measurement location 304 of the site. As seen in the example shown in FIG. 6, an additional wireless access device 112b has been added to the site 300 under survey resulting in a total of four wireless access devices 112 deployed at the site. Additionally the user has relocated the wireless access devices 112 to new locations in the site 300 under survey shown by way of example in FIG. 6. As a result, the measurement locations 304b that did not receive adequate wireless service in FIG. 5, receive adequate wireless service in FIG. 6 with the addition of another wireless access device 112b and the relocation of the wireless access devices 112 at the site 300.

The user may repeat the wireless site surveys at the measurement locations 304b that previously did not receive adequate wireless access. Having added another wireless access device 112b and relocated the wireless access devices 112 at the site 300 as shown in FIG. 6, the wireless network design system 100 may thus determine that wireless signals received at those locations currently satisfy the wireless network design criteria. Accordingly the wireless network design system 100 affords an efficient approach to conducing wireless site surveys and establishing a robust wireless environment.

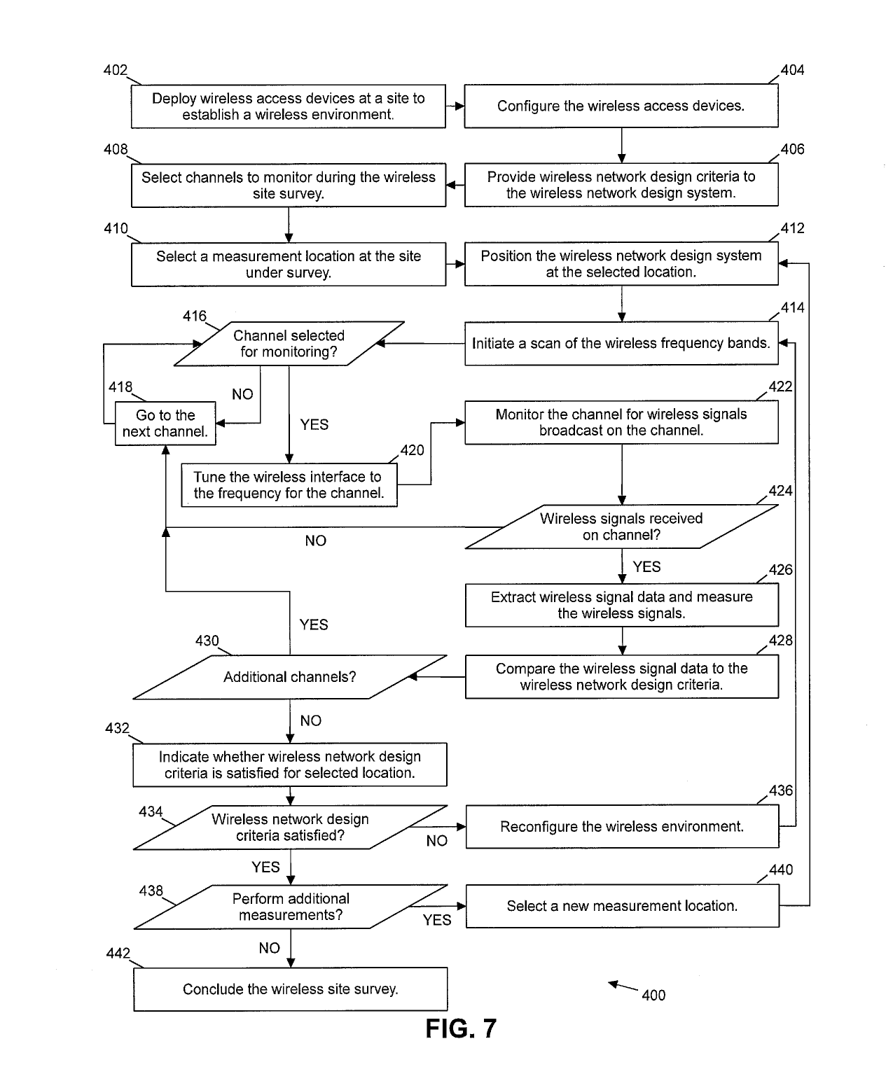

Referring now to FIG. 7, a flowchart 400 of example method steps for conducting a wireless site survey using wireless network design criteria 120 is shown. A user may begin by deploying one or more wireless access devices 112 at a site in order to establish a wireless networking environment at that site (step 402). The wireless access devices 112 may be, for example, wireless arrays that include multiple access points 114. Once deployed at the site, the user may configure the wireless access devices 112 to provide wireless service (step 404). Configuring the wireless access devices 112 may include, for example, setting the wireless access devices to operate in the 2.4 GHz or 5 GHz frequency bands and setting the access points 114 to operate on a particular channel, e.g., channel 9 in the 2.4 GHz frequency band.

The user may then provide a wireless network design system 100 with a set of wireless network design criteria 120 (step 406). The wireless network design criteria 120 may correspond to a desired quality of wireless service observed at the site under survey. The wireless network design criteria 120 may include, for example, a desired signal strength threshold or range, a desired number of observed wireless access devices 112 or access points 114, and a signal-to-noise ratio as discussed above. The user may also select, using the wireless network design system 100, a set of channels to monitor during the wireless site survey (step 408). For example, if the user configures the wireless access devices 112 to broadcast on certain channels, the user may select only those channels to monitor during the wireless site survey.

The user may then select a measurement location at the site under survey at which to monitor wireless signals broadcast by the wireless access devices 112 (step 410). The user may position the wireless network design system 100 at the selected location (step 412) and initiate a scan of the wireless frequency bands (step 414) to measure wireless signals received at the selected location. As discussed above, the wireless interface controller 110 of the wireless network designer 102 scans the channels of the wireless frequency bands during the wireless site survey. If the user has not selected a particular channel (step 416), the channel filter 130 instructs the wireless interface controller 116 to skip to the next channel in the frequency band (step 418). If the user has selected a channel for monitoring (step 416), then the wireless interface controller 116 instructs the wireless interface 110 to tune to the frequency for the selected channel (step 420). The wireless network designer 102 then monitors the channel for wireless signals broadcast by the wireless access devices 112 on that channel and received at the wireless interface 110 (step 422). If wireless signals are received on the channel (step 424), then the measurement module 124 may extract wireless signal data from the wireless signals and measure the wireless signals as discussed above (step 426). The analysis module 126 may then compare the extracted wireless signal data and measurements to the wireless network design criteria 120 (step 428) to determine whether the wireless network design criteria 120 is satisfied as also discussed above. If there are additional channels in the frequency bands to monitor (step 430), the wireless interface 110 may go to the next channel (step 418) and repeat steps 416-428 to measure any wireless signals received at the next channel.

If there are no additional channels to monitor (step 430), then the wireless networking design system 100 may indicate whether the set of wireless network design criteria 120 is satisfied. The wireless network design system 100 may indicate whether the set of design criteria 120 is satisfied (step 432) using visual indicators presented on a user interface that is displayed on a display device 108 or audible indicators output from an audio output device 106 as discussed above.

If the wireless network design system 100 indicates that the set of wireless network design criteria is not satisfied at the selected location (step 434), the user may reconfigure the wireless environment (step 436) and repeat steps 414-434 to conduct a wireless site survey in the reconfigured wireless environment. If the wireless network design system 100 indicates that the set of wireless network design criteria is satisfied at the selected location (step 434), the user may decide to perform additional measurements (step 438) at another location of the site. Accordingly, the user may select a new measurement location at the site (step 440), position the wireless network design system 100 at the newly selected location (step 412), and repeat steps 414-438 to perform a wireless site survey at the newly selected location. If the user has conducted a wireless site scan at all desired locations, the user may conclude the wireless site survey (step 442).

It will be understood that the example steps shown in the flowchart 400 of FIG. 7 are by way of example only. The steps may be selectively performed in alternative orders. For example, a user may collect wireless signals at multiple measurement locations before measuring and analyzing the signals. Thus the user may, in this example, wait to reconfigure the wireless environment until all measurement locations have been surveyed.

It will also be understood and appreciated that one or more of the processes, sub-processes, and process steps described in connection with FIGS. 1-7 may be performed by hardware, software, or a combination of hardware and software on one or more electronic or digitally-controlled devices. The software may reside in a software memory (not shown) in a suitable electronic processing component or system such as, for example, one or more of the functional systems, devices, components, modules, or sub-modules schematically depicted in FIG. 1. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module, which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., a wireless network design system in FIG. 1), direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that the term “in signal communication” as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A system for conducting wireless site surveys of a wireless environment comprising:
a wireless interface controller that controls a wireless interface during a scan of a wireless frequency band;
a user interface module that receives a set of wireless network design criteria;
a measurement module that obtains a set of wireless signal information based on a set of wireless signals received during the scan of the wireless frequency band;
an analysis module that compares the set of wireless signal information to the set of wireless network design criteria and automatically determines whether the set of wireless network design criteria is, at least in part, satisfied; and
wherein the user interface module provides an indicator that indicates whether the set of wireless network design criteria is, at least in part, satisfied.

2. The system of claim 1 wherein:
the analysis module determines that the set of wireless network design criteria is satisfied when each wireless network design criterion in the set of wireless network design criteria is satisfied; and
the analysis module determines that the set of wireless network design criteria is not satisfied when at least one wireless network design criterion in the set of wireless network design criteria is not satisfied.

3. The system of claim 2 wherein the analysis module determines that a wireless network design criterion in the set of wireless network design criteria is satisfied when a predetermined amount of wireless signals in the set of wireless signals satisfy the wireless network design criterion.

4. The system of claim 3 wherein the predetermined amount of wireless signals that satisfy the network design criterion is a predetermined percentage of wireless signals in the set of wireless signals that satisfy the wireless network design criterion.

5. The system of claim 2 wherein the analysis module determines that a wireless network design criterion in the set of wireless network design criteria is not satisfied when a predetermined amount of wireless signals in the set of wireless signals do not satisfy the wireless network design criterion.

6. The system of claim 2 wherein the indicator that indicates whether the set of wireless network design criteria is satisfied includes a global indicator that indicates whether each wireless network design criterion in the set of wireless network design criteria is satisfied.

7. The system of claim 6 wherein:
the global indicator includes a visual indicator;
the user interface module selects a first color for the global indicator when the set of wireless network criteria is satisfied; and
the user interface module selects a second color for the global indicator different from the first color when the set of wireless network design criteria is not satisfied.

8. The system of claim 6 wherein the global indicator includes an audible indicator and playback of the audible indicator is initiated in response to a determination that the set of wireless network design criteria is satisfied.

9. The system of claim 1 wherein:
individual wireless signals in the set of wireless signals are respectively associated with a channel of the wireless frequency band; and
the user interface module provides a display that includes a table of channels observed during the scan of the wireless frequency band, the channels observed during the scan of the wireless frequency band are respectively associated with line items of the table.

10. The system of claim 9 wherein individual line items in the table are respectively displayed with a line item background color that indicates whether wireless signals broadcast on the channel associated with the line item satisfy the set of wireless network design criteria.

11. The system of claim 10 wherein:
the user interface module sets the line item background color to a first color when a first predetermined amount of wireless signals broadcast on the channel associated with the line item satisfy the set of wireless network design criteria; and
the user interface module sets the line item background color to a second color different from the first color when a second predetermined amount of wireless signals broadcast on the channel associated with the line item do not satisfy at least one wireless network design criterion in the set of wireless network design criteria.

12. The system of claim 1 wherein:
the set of wireless network design criteria includes at least one of: (1) a minimum number of wireless access devices observed in the wireless environment during the scan of the wireless frequency band, (2) a minimum number of wireless access points observed in the wireless environment during the scan of the wireless frequency band, (3) a minimum signal strength value, and (4) a maximum signal-to-noise ratio observed in the wireless environment during the scan of the wireless frequency band; and
the set of wireless signal information includes at least one of: (a) an observed number of wireless access devices, (b) an observed number of wireless access points, (c) a set of observed signal strength values respectively corresponding to individual wireless signals in the set of wireless signals, and (d) an observed signal-to-noise ratio in the wireless environment.

13. The system of claim 12 wherein the analysis module determines that the set of wireless network design criteria is satisfied when:
(i) the observed number of wireless access devices or the observed number of wireless access points at least equals the minimum number of wireless access devices or the minimum number of wireless access points respectively;
(ii) individual observed signal strength values in the set of observed signal strength values at least equal the minimum signal strength value; and
(iii) the observed signal-to-noise ratio is below the maximum signal-to-noise ratio.

14. The system of claim 1 further comprising a channel filter that instructs the wireless interface controller to selectively monitor a set of selected channels in the wireless frequency band during the scan of the wireless frequency band such that the wireless interface controller does not monitor unselected channels during the scan of the wireless frequency band.

15. The system of claim 1 wherein:
the wireless interface controller controls the wireless interface during a plurality of scans of the wireless frequency band;
individual scans in the plurality of scans are respectively performed at a set of locations within the wireless environment;
the measurement module obtains a plurality of sets of wireless signal information respectively based on a plurality of sets of wireless signals received during the plurality of scans of the wireless frequency band;
individual sets of wireless signals in the plurality of sets of wireless signals are respectively associated with individual locations in the set of locations within the wireless environment; and
the analysis module determines whether the set of wireless network design criteria is, at least in part, satisfied based on the plurality of sets of wireless signal information.

16. The system of claim 1 wherein the wireless frequency band includes the 2.4 GHz frequency band and the 5 GHz wireless frequency band.

17. A computer-implemented method of conducting a wireless site survey for a wireless environment comprising:
receiving a set of wireless network design criteria;
scanning a wireless frequency band to receive a set of wireless signals;
measuring individual wireless signals in the set of wireless signals to obtain a set of wireless signal information associated with the set of wireless signals;
comparing the set of wireless signal information to the set of wireless network design criteria;
determining whether the set of wireless network design criteria is, at least in part, satisfied; and
providing an indicator that indicates whether the set of wireless network design criteria is, at least in part, satisfied.

18. The computer-implemented method of claim 17 further comprising:
determining that the set of wireless network design criteria is satisfied when each wireless network design criterion in the set of wireless network design criteria is satisfied; and
determining that the set of wireless network design criteria is not satisfied when at least one wireless network design criterion in the set of wireless network design criteria is not satisfied.

19. The computer-implemented method of claim 18 further comprising determining that a wireless network design criterion in the set of wireless network design criteria is satisfied when a predetermined amount of wireless signals in the set of wireless signals satisfy the wireless network design criterion.

20. The computer-implemented method of claim 19 wherein the predetermined amount of wireless signals that satisfy the wireless network design criterion is a predetermined percentage of wireless signals in the set of wireless signals that satisfy the wireless network design criterion.

21. The computer-implemented method of claim 18 further comprising determining that a wireless network design criterion in the set of wireless network design criteria is not satisfied when a predetermined amount of wireless signals in the set of wireless signals do not satisfy the wireless network design criterion.

22. The computer-implemented method of claim 18 wherein the indicator that indicates whether the set of wireless network design criteria is satisfied includes a global indicator that indicates whether each wireless network design criterion in the set of wireless network design criteria is satisfied.

23. The computer-implemented method of claim 22 wherein the global indicator includes a visual indicator and further comprising:
selecting a first color for the global indicator when the set of wireless network design criteria is satisfied; and
selecting a second color for the global indicator different from the first color when the set of wireless network design criteria is not satisfied.

24. The computer-implemented method of claim 22 wherein the global indicator includes an audible indicator and further comprising initiating playback of the audible indicator in response to a determination that the set of wireless network design criteria is satisfied.

25. The computer-implemented method of claim 17 wherein individual wireless signals in the set of wireless signals are respectively associated with a channel of the wireless frequency band and further comprising providing a display that includes a table of channels observed while scanning the wireless frequency band wherein the channels observed while scanning the wireless frequency band are respectively associated with line items of the table.

26. The computer-implemented method of claim 25 further comprising respectively configuring individual line items in the table with a line item background color that indicates whether wireless signals broadcast on the channel associated with the line item satisfy the set of wireless-network design criteria.

27. The computer-implemented method of claim 26 further comprising:
setting the line item background color to a first color when a first predetermined amount of wireless signals broadcast on the channel associated with the line item satisfy the set of wireless network design criteria; and
setting the line item background color to a second color different from the first color when a second predetermined amount of wireless signals broadcast on the channel associated with the line item do not satisfy at least one wireless network design criterion in the set of wireless network design criteria.

28. The computer-implemented method of claim 17 wherein:
the set of wireless network design criteria includes at least one of: (1) a minimum number of wireless access devices observed in the wireless environment during the scan of the wireless frequency band, (2) a minimum number of wireless access points observed in the wireless environment during the scan of the wireless frequency band, (3) a minimum signal strength value, and (4) a maximum signal-to-noise ratio observed in the wireless environment during the scan of the wireless frequency band; and
the set of wireless signal information includes at least one of: (a) an observed number of wireless access devices, (b) an observed number of wireless access points, (c) a set of observed signal strength values respectively corresponding to individual wireless signals in the set of wireless signals, and (d) an observed signal-to-noise ratio in the wireless environment.

29. The computer-implemented method of claim 28 further comprising determining that the set of wireless network design criteria is satisfied in response to:
(i) determining that the observed number of wireless access devices or the observed number of wireless access points at least equals the minimum number of wireless access devices or the minimum number of wireless access points respectively;
(ii) determining that individual observed signal strength values in the set of observed signal strength values at least equal the minimum signal strength value; and
(iii) determining that the observed signal-to-noise ratio is below the maximum signal-to-noise ratio.

30. The computer-implemented method of claim 17 further comprising selectively monitoring a set of selected channels in the wireless frequency band while scanning the wireless frequency band such that unselected channels are not monitored while scanning the wireless frequency band.

31. The computer-implemented method of claim 17 further comprising:
scanning the wireless frequency band at a plurality of locations within the wireless environment to receive a plurality of sets of wireless signals wherein individual sets of wireless signals of the plurality of sets of wireless signals are respectively associated with individual locations of the plurality of locations;
obtaining a plurality of sets of wireless signal information respectively based on the plurality of sets of wireless signals; and
determining whether the set of wireless network design criteria is, at least in part, satisfied based on the plurality of sets of wireless signal information.

32. The computer-implemented method of claim 17 wherein the wireless frequency band include the IEEE 802.11 2.4 GHz frequency band and the IEEE 802.11 5 GHz frequency band.

33. A method of conducting a wireless site survey for a wireless environment comprising:
providing a set of wireless network design criteria to a wireless network design system;
positioning the wireless network design system at a location within the wireless environment;
scanning a wireless frequency band using the wireless network design system;
determining whether the set of wireless network design criteria is, at least in part, satisfied based on an indicator automatically provided by the wireless network design system; and
reconfiguring the wireless environment when the indicator provided by the wireless network design system indicates that at least one wireless network design criterion in the set of wireless network design criteria is not satisfied.

34. The method of claim 33 wherein the wireless network design system measures wireless signals broadcast by one or more wireless access points deployed in the wireless environment and determines whether the set of wireless network design criteria is, at least in part, satisfied based on a set of wireless signal information associated with a set of wireless signals received at the wireless network design system while scanning the wireless frequency band.

35. The method of claim 34 wherein reconfiguring the wireless environment includes at least one of:
adjusting a number of wireless access devices deployed in the wireless environment;
adjusting a number of wireless access points deployed in the wireless environment;
adjusting respective locations of wireless access devices within the wireless environment;
adjusting respective orientations of wireless access devices or wireless access points within the wireless environment;
replacing one or more wireless access devices of a first wireless access device type with one or more wireless access devices of a second wireless access device type different from the first wireless access device type;
adjusting respective channel assignments among one or more wireless access devices or wireless access points; and
adjusting the transmitting power of one or more wireless access devices or wireless access points.

36. The method of claim 33 further comprising:
positioning the wireless network design system at a plurality of locations within the wireless environment;
scanning the wireless frequency band at individual locations of the plurality of locations using the wireless network design system such that the wireless network design system receives a plurality of sets of wireless signals wherein individual sets of wireless signals of the plurality of sets of wireless signals are respectively associated with the individual locations within the wireless environment; and
wherein the indicator automatically provided by the wireless network design system indicates whether the set of wireless network design criteria is, at least in part, satisfied based on a plurality of sets of wireless signal information respectively associated with the plurality of sets of wireless signals.
